(19) United States
(12) Patent Application Publication
(10) Pub. No.: US 2025/0038227 A1
(43) Pub. Date: Jan. 30, 2025

(54) FUEL CELL SYSTEM GLOW PLUG

(71) Applicant: BLOOM ENERGY CORPORATION, San Jose, CA (US)

(72) Inventors: Vivek SINGH, Mumbai (IN); Michael PETRUCHA, Santa Clara, CA (US); Mohammad KHAN, Mumbai (IN); Shraddesh MALVIYA, Mumbai (IN); Srikanth RANGANATHAN, Fremont, CA (US)

(21) Appl. No.: 18/782,644

(22) Filed: Jul. 24, 2024

Related U.S. Application Data
(60) Provisional application No. 63/528,786, filed on Jul. 25, 2023.

(51) Int. Cl. H01M 8/04007; H01M 8/0276; H01M 8/0282; H01M 8/04701; H01M 8/0612; H01M 8/12

(52) U.S. Cl. CPC H01M 8/04037; H01M 8/0278; H01M 8/0282; H01M 8/04708; H01M 8/0618; H01M 2008/1293

(57) ABSTRACT

A glow plug includes a housing formed of a metal or metal alloy and having a first end having a first opening, and an opposing second end having a second opening, a heating element extending through the first opening and having a working end that is exposed outside of the first end of the housing and an opposing terminal end that is located inside of the housing, a brazed sealant assembly connected to the second end of the housing, first and second terminal wires that extend through the brazed sealant assembly and are electrically connected to the terminal end of the heating element, and a dielectric disk located inside of the housing and surrounding a portion of the terminal end of the heating element.

### FIELD

Aspects of the present invention relate to electrochemical cell system components, and more particularly, to fuel cell system glow plugs.

### BACKGROUND

Fuel cells, such as solid oxide fuel cells, are electrochemical devices which can convert energy stored in fuels to electrical energy with high efficiency. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a glow plug includes a housing formed of a metal or metal alloy and having a first end having a first opening and an opposing second end having a second opening, a heating element extending through the first opening and having a working end that is exposed outside of the first end of the housing and an opposing terminal end that is located inside of the housing, a brazed sealant assembly connected to the second end of the housing; first and second terminal wires that extend through the brazed sealant assembly and are electrically connected to the terminal end of the heating element, and a dielectric disk located inside of the housing and surrounding a portion of the terminal end of the heating element.

According to various embodiments, a catalytic partial oxidation (CPOx) reactor includes a CPOx housing surrounding a reaction zone, a catalyst located in the reaction zone, and a glow plug that extends through the CPOx housing into the reaction zone and that is located upstream of the catalyst with respect to a fuel flow direction through the CPOx reactor.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic of a fuel cell system, according to various embodiments of the present disclosure.

FIG. 2A is a sectional view showing components of the hotbox of the system of FIG. 1, FIG. 2B shows an enlarged portion of the system of FIG. 2A, FIG. 2C is a three-dimensional cut-away view of a central column of the system of FIG. 2A, and FIG. 2D is a perspective view of an anode hub structure located below the central column of the system of FIG. 2A, according to various embodiments of the present disclosure.

FIG. 3A is a perspective view of a glow plug, according to various embodiments of the present disclosure, and FIG. 3B is a partially transparent view showing internal components of the glow plug of FIG. 3A.

FIG. 4A is a perspective view of the glow plug with a brazed sealant assembly removed. FIGS. 4B and 4C are perspective views of the brazed sealant assembly. FIG. 4D is an exploded view of the brazed sealant assembly, and FIG. 4E is a cross-sectional view of the brazed sealant assembly.

FIG. 5A is a perspective view of a glow plug and first and second temperature sensors being inserted into a CPOx reactor, and FIG. 5B is a schematic cross-sectional view of the CPOx reactor containing the glow plug and temperature sensors, according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. In some embodiments, a value of “about X” may include values of +/−1% X. It will be further understood that the endpoints of each of the ranges are significant both in relation to the other endpoint, and independently of the other endpoint.

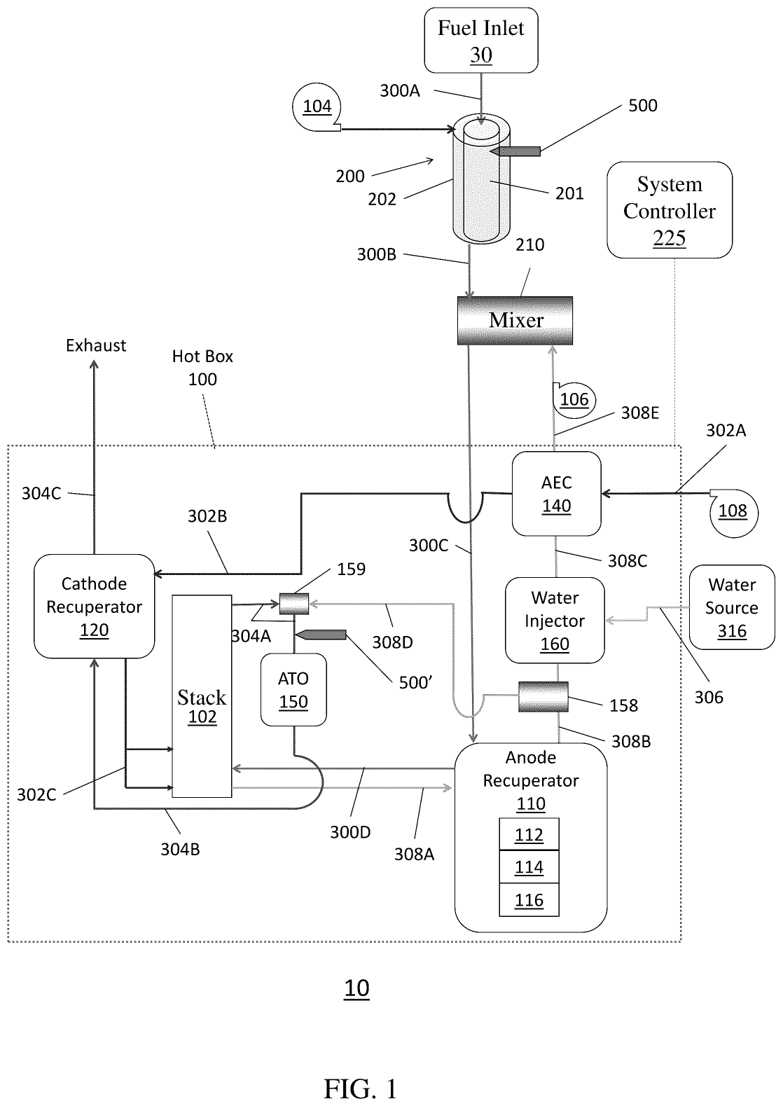

FIG. 1 is a schematic representation of a solid oxide fuel cell (SOFC) system 10, according to various embodiments of the present disclosure. Referring to FIG. 1, the system 10 includes a hotbox 100 and various components disposed therein or adjacent thereto. The hotbox 100 may contain stacks (e.g., fuel cell stacks) 102 containing alternating fuel cells, such as solid oxide fuel cells, and interconnects. Thus, in one embodiment, the stacks 102 may comprise SOFC stacks. One solid oxide fuel cell of the stack 102 contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be internally or externally manifolded for fuel, and may be arranged over each other in a plurality of columns.

The hotbox 100 may also contain an anode recuperator heat exchanger 110, a cathode recuperator heat exchanger 120, an anode tail gas oxidizer (ATO) 150, an anode exhaust cooler heat exchanger 140, a splitter 158, a vortex generator 159, and a water injector 160. The system 10 may also include a catalytic partial oxidation (CPOx) reactor 200, a mixer 210, a CPOx blower 104 (e.g., air blower), a main air blower 108 (e.g., system blower), and an anode recycle blower 106, which may be disposed outside of the hotbox 100. However, the present disclosure is not limited to any particular location for each of the components with respect to the hotbox 100.

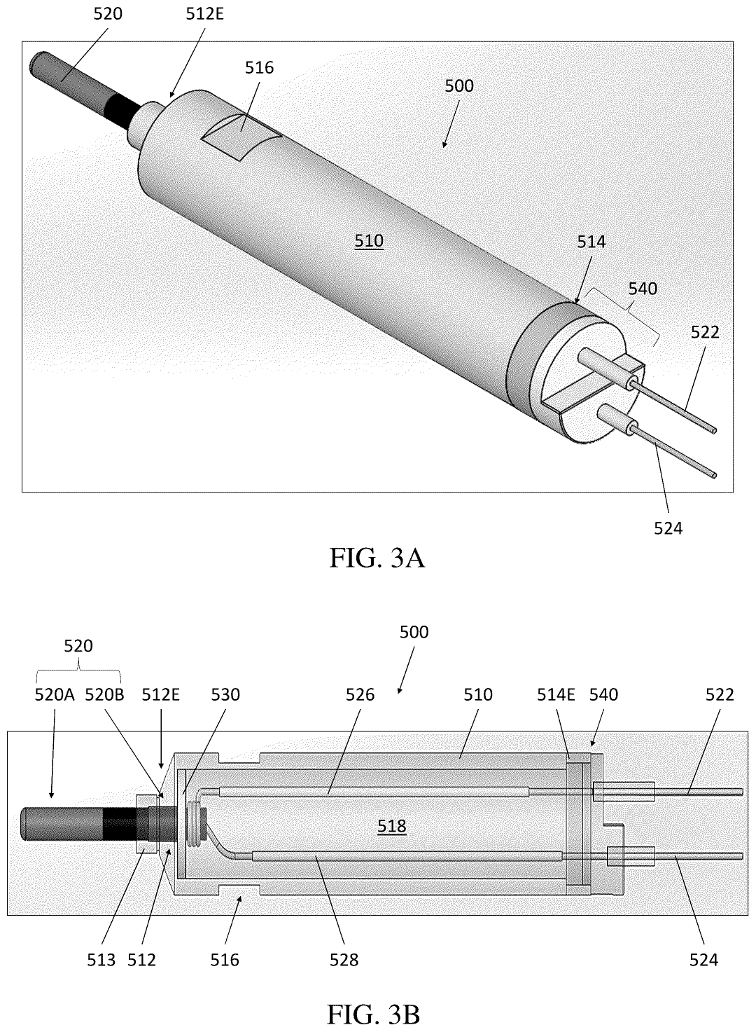

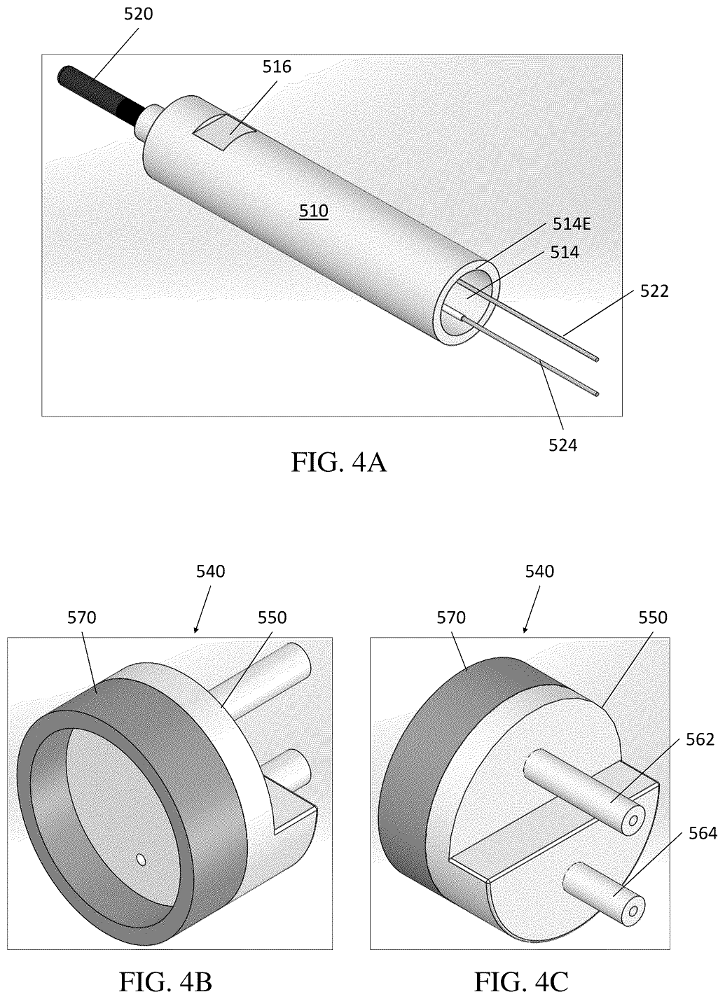

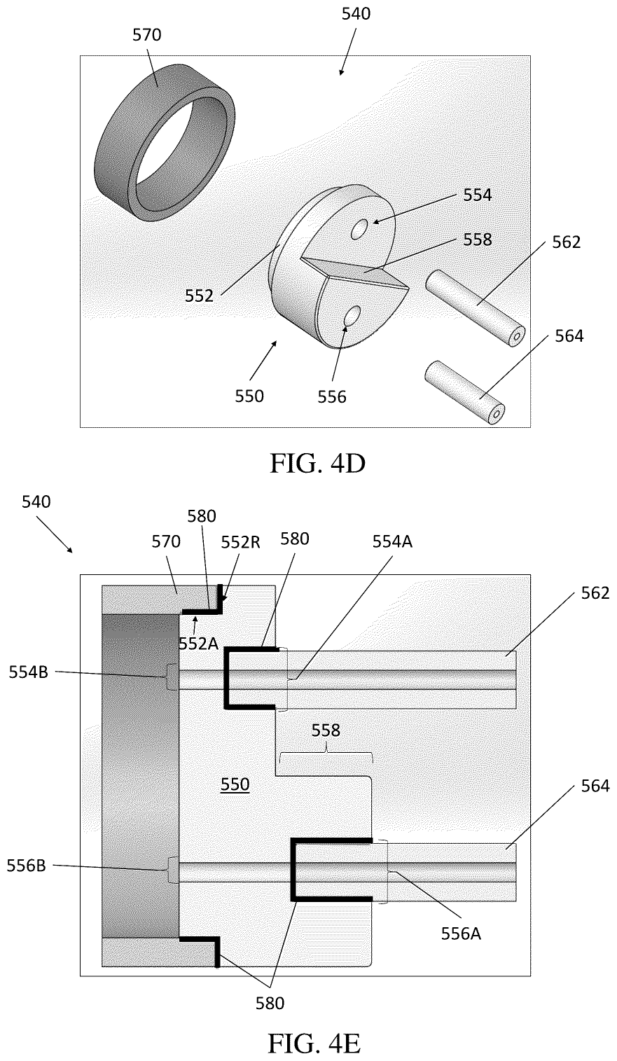

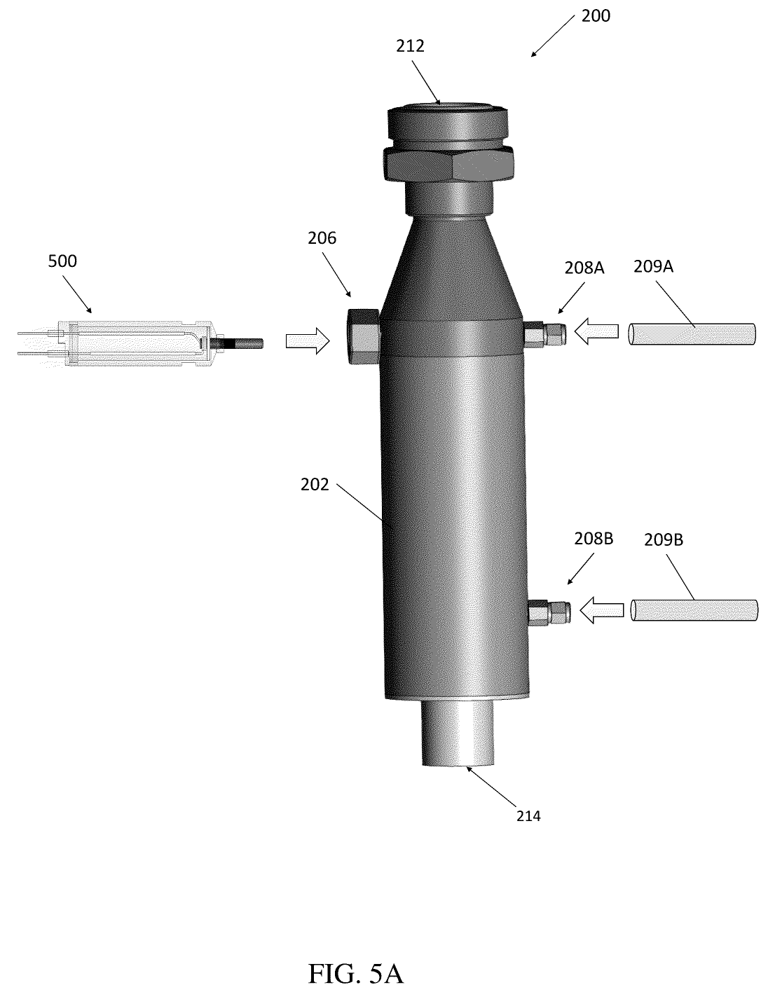

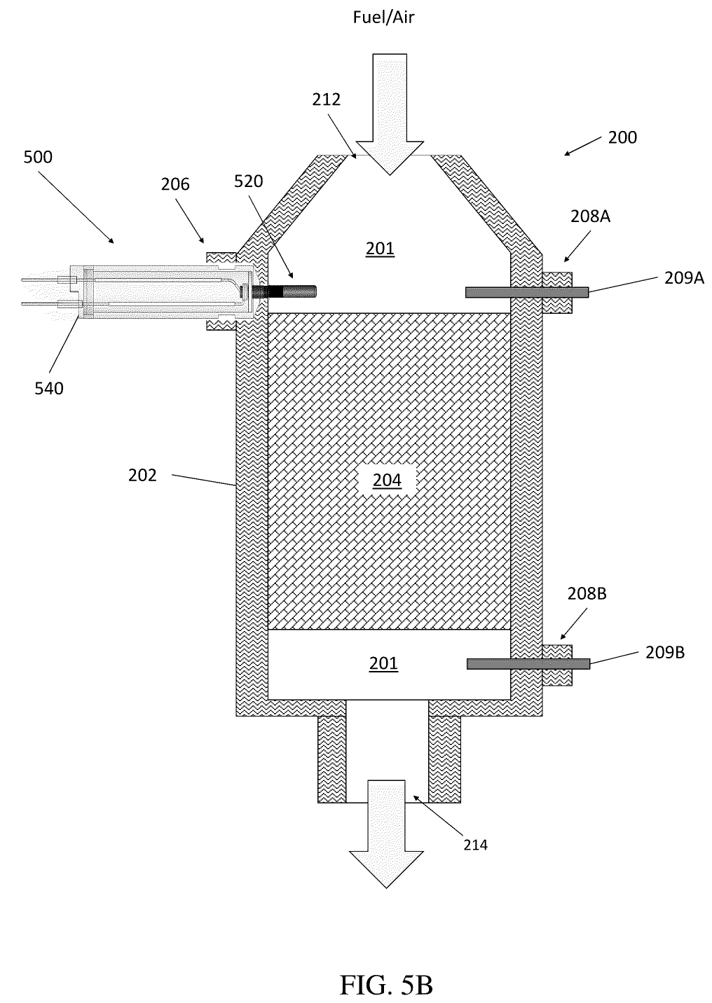

The CPOx reactor 200 may include a reaction zone 201 containing an oxidation catalyst configured to partially oxidize a fuel. During system startup, a heat source may be used to initiate the oxidation reaction in the CPOx reactor 200, which may be referred to as “light-off”. In various embodiments, the system 10 may include a glow plug 500 configured to provide heat to initiate light-off of the CPOx reactor 200. In particular, one end of the glow plug 500 may be inserted into the reaction zone 201 and hermetically sealed within an opening in a housing 202 of the CPOx reactor 200, as shown in FIG. 5B. The glow plug 500 will be described in more detail below with respect to FIGS. 3A, 3B, and 4A-4D.

The CPOx reactor 200 receives a fuel inlet stream from a fuel inlet 30, through fuel conduit 300A. The fuel inlet 30 may be a fuel tank or a utility natural gas line including a valve to control an amount of fuel provided to the CPOx reactor 200. The CPOx blower 104 may provide air to the CPOx reactor 200 during system start-up. The fuel and/or air may be provided to the mixer 210 by fuel conduit 300B. Fuel (e.g., the fuel inlet stream) flows from the mixer 210 to the anode recuperator 110 through fuel conduit 300C. The fuel is heated in the anode recuperator 110 by a portion of the fuel exhaust and the fuel then flows from the anode recuperator 110 to the stack 102 through fuel conduit 300D.

The main air blower 108 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C.

An anode exhaust stream (e.g., the fuel exhaust stream) generated in the stack 102 is provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 158 by anode exhaust conduit 308B. A first portion of the anode exhaust may be provided from the splitter 158 to the anode exhaust cooler 140 through the water injector 160 and the anode exhaust conduit 308C. A second portion of the anode exhaust is provided from the splitter 158 to the ATO 150 through the anode exhaust conduit 308D. The first portion of the anode exhaust heats the air inlet stream in the anode exhaust cooler 140 and may then be provided from the anode exhaust cooler 140 to the mixer 210 through the anode exhaust conduit 308E. The anode recycle blower 106 may be configured to move anode exhaust through anode exhaust conduit 308E, as discussed below.

Cathode exhaust generated in the stack 102 flows to the ATO 150 through exhaust conduit 304A. The vortex generator 159 may be disposed in exhaust conduit 304A and may be configured to swirl the cathode exhaust. The anode exhaust conduit 308D may be fluidly connected to the vortex generator 159 or to the cathode exhaust conduit 304A or the ATO 150 downstream of the vortex generator 159. The swirled cathode exhaust may mix with the second portion of the anode exhaust provided by the splitter 158 before being provided to the ATO 150. The mixture may be oxidized in the ATO 150 to generate an ATO exhaust. The ATO exhaust flows from the ATO 150 to the cathode recuperator 120 through exhaust conduit 304B. Exhaust flows from the cathode recuperator and out of the hotbox 100 through exhaust conduit 304C.

During system startup, a heat source may be used to initiate an oxidation reaction in the ATO 150. In various embodiments, the system 10 may include an ATO glow plug 500′ configured to heat the fuel mixture provided to the ATO 150. The ATO glow plug 500′ may be fluidly connected upstream of the ATO 150 and may be sealed within an opening in the housing of the hotbox 100.

Water flows from a water source 316, such as a water tank or a water pipe, to the water injector 160 through water conduit 306. The water injector 160 injects water directly into a first portion of the anode exhaust provided in anode exhaust conduit 308C. Heat from the first portion of the anode exhaust (also referred to as a recycled anode exhaust stream) provided in anode exhaust conduit 308C vaporizes the water to generate steam. The steam mixes with the anode exhaust, and the resultant mixture is provided to the anode exhaust cooler 140. The mixture is then provided from the anode exhaust cooler 140 to the mixer 210 through the anode exhaust conduit 308E. The mixer 210 is configured to mix the steam and first portion of the anode exhaust with fresh fuel (i.e., fuel inlet stream). This humidified fuel mixture may then be heated in the anode recuperator 110 by the anode exhaust, before being provided to the stack 102. The system 10 may also include one or more fuel reforming catalysts 112, 114, and 116 located inside and/or downstream of the anode recuperator 110. The reforming catalyst(s) reform the humidified fuel mixture before it is provided to the stack 102.

The system 10 may further include a system controller 225 configured to control various elements of the system 10. The controller 225 may include a central processing unit configured to execute stored instructions. For example, the controller 225 may be configured to control fuel and/or air flow through the system 10, according to fuel composition data.

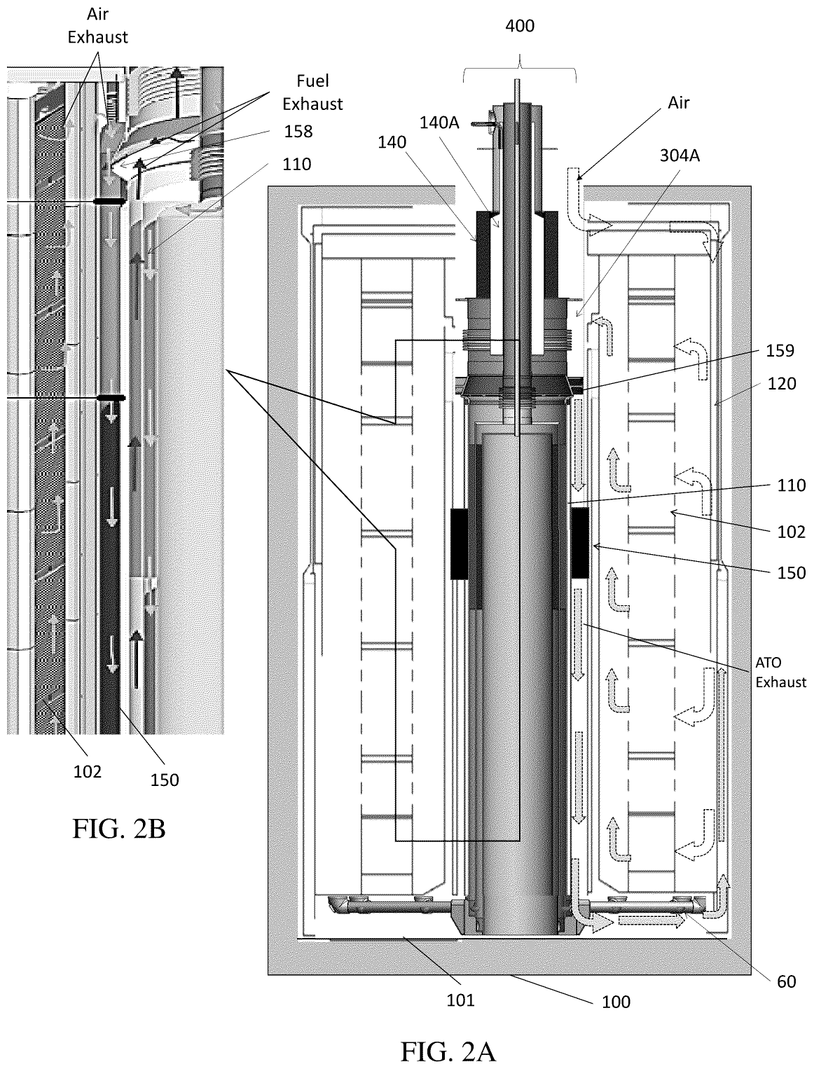

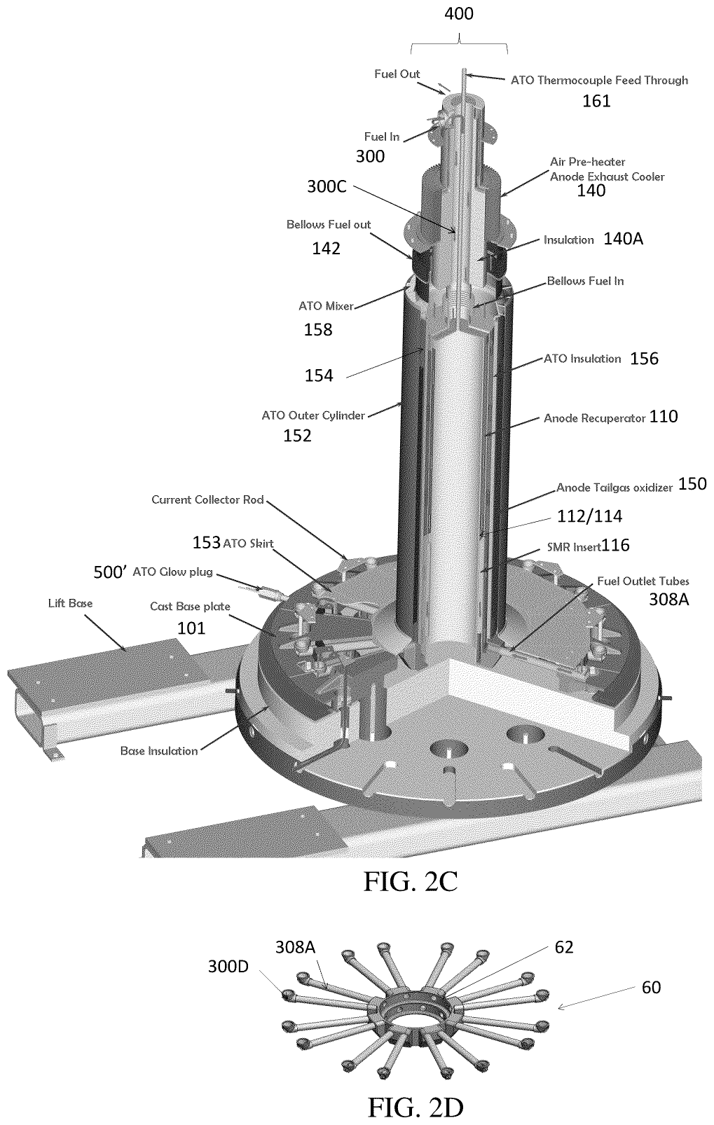

FIG. 2A is a sectional view showing components of the hotbox 100 of the system 10 of FIG. 1, and FIG. 2B shows an enlarged portion of FIG. 2A. FIG. 2C is a three-dimensional cut-away view of a central column 400 of the system 10, according to various embodiments of the present disclosure, and FIG. 2D is a perspective view of an anode hub structure 60 disposed in a hotbox base 101 on which the column 400 may be disposed.

Referring to FIGS. 2A-2D, the fuel cell stacks 102 may be disposed around the central column 400 in the hotbox 100. For example, the stacks 102 may be disposed in a ring configuration around the central column 400 and may be positioned on the hotbox base 101. The column 400 may include the anode recuperator 110, the ATO 150, and the anode exhaust cooler 140. In particular, the anode recuperator 110 is disposed radially inward of the ATO 150, and the anode exhaust cooler 140 is mounted over the anode recuperator 110 and the ATO 150. Anode exhaust cooler inner core insulation 140A may be located between the fuel conduit 300C and the combination of the anode exhaust cooler 140 and the bellows 142 underlying the anode exhaust cooler 140. In one embodiment, an oxidation catalyst 112 and/or a hydrogenation catalyst 114 may be located in the anode recuperator 110. A reforming catalyst 116 may also be located at the bottom of the anode recuperator 110 as a steam methane reformation (SMR) insert.

The ATO 150 comprises an outer cylinder 152 that is positioned around the outer wall of the anode recuperator 110. Optionally, ATO insulation 156 may be enclosed by an ATO inner cylinder 154. Thus, the insulation 156 may be located between the anode recuperator 110 and the ATO 150. An ATO oxidation catalyst may be located in the space between the outer cylinder 152 and the ATO insulation 156. An ATO thermocouple feedthrough 161 extends through the anode exhaust cooler 140, to the top of the ATO 150. The temperature of the ATO 150 may thereby be monitored by inserting one or more thermocouples (not shown) through this feedthrough 161.

The anode hub structure 60 may be positioned under the anode recuperator 110 and ATO 150 and over the hotbox base 101. The anode hub structure 60 is covered by an ATO skirt 153. The vortex generator 159 and fuel exhaust splitter 158 are located over the anode recuperator 110 and ATO 150 and below the anode exhaust cooler 140. The ATO glow plug 500′, which initiates the oxidation of the stack fuel exhaust in the ATO during startup, may be located near the bottom of the ATO 150.

The anode hub structure 60 is used to distribute fuel evenly from the central column to fuel cell stacks 102 disposed around the central column 400. The anode hub structure 60 includes a grooved cast base 62 and a “spider” hub of fuel inlet conduits 300D and anode exhaust conduits 308A. Each pair of conduits 300D, 308A connects to a fuel cell stack 102 (or column of fuel cell stacks 102). Anode side cylinders (e.g., anode recuperator 110 inner and outer cylinders and ATO outer cylinder 152) are then welded or brazed into the grooves in the base 62, creating a uniform volume cross section for flow distribution as discussed below.

As shown by the arrows in FIGS. 2A and 2B, air enters the top of the hotbox 100 and then flows into the cathode recuperator 120 where it is heated by ATO exhaust output from the ATO 150. The ATO exhaust then flows through the cathode recuperator 120 and then exits the hotbox 100.

For solid oxide fuel cells, the air then flows through the stacks 102, such that oxygen ions diffuse from the cathode electrodes through the fuel cell electrolytes to the anode electrodes and react with fuel (i.e., fuel inlet stream) provided from the anode hub structure 60 to the anode electrodes of the fuel cells. Air exhaust flows from the stacks 102 and then passes through vanes of the vortex generator 159 and is swirled before entering the ATO 150.

The splitter 158 may direct the second portion of the fuel exhaust exiting the top of the anode recuperator 110 through openings (e.g., slits) in the splitter into the swirled air exhaust (e.g., in the vortex generator 159 or downstream of the vortex generator 159 in exhaust conduit 304A or in the ATO 150). Thus, the fuel and air exhaust may be mixed before entering the ATO 150.

### Glow Plug

FIG. 3A is a perspective view of the glow plug 500, according to various embodiments of the present disclosure. FIG. 3B is a partially transparent view showing internal components of the glow plug 500 of FIG. 3A.

Referring to FIGS. 3A and 3B, the glow plug 500 may be hermetically sealed and may have high-temperature, voltage, and thermal cycle stability. For example, the glow plug 500 may be configured to withstand temperatures of at least 800° C., for a time period of at least 25,000 hours.

The glow plug 500 may include a housing 510, a heating element 520, a first terminal wire 522, a second terminal wire 524, a dielectric disk 530, and a brazed sealant assembly 540. The housing 510 may be a hollow cylindrical structure including a tapered first end 512E containing a first opening 512 and an opposing second end 514E containing a second opening 514 to the inner volume of the housing. Optional threads 513 may surround the heating element between the first end 512E of the housing 510 and the tip of the heating element 520. Connection grooves 516 may be formed in an outer surface of the housing 510 adjacent to the first opening 512. The connection grooves 516 may be configured to facilitate connection of the glow plug 500 to components of a fuel cell system. For example, the connection grooves 516 may be mated to the sidewall of the CPOx reactor 200 housing 202 if the glow plug 500 is used in the CPOx reactor 200, or to the sidewall of the hotbox 100 housing if the glow plug 500 is used as the ATO glow plug 500′. The housing 510 may be formed of a high-temperature stable metal or metal alloy, such as stainless steel or the like. For example, the housing 510 may be formed of a chromium-nickel containing stainless steel alloy, such as stainless steel 316, stainless steel 310 or nickel-chromium alloy, such as Inconel 625.

The heating element 520 may be a resistive heating element that extends through the first opening 512, such that a working end 520A of the heating element 520 is exposed outside of the housing 510 and an opposing terminal end 520B of the heating element 520 is disposed inside of the housing 510. The heating element 520 may include a heating core disposed in a dielectric cladding or matrix. In some embodiments, the heating core may comprise an electrically conductive material. The electrically conductive material may comprise a metal or metal alloy, such as a metal silicide, for example molybdenum disilicide (MoSi₂). The cladding or matrix may comprise a dielectric material, such as silicon nitride or the like. In one embodiment, the core is surrounded by the cladding. In another embodiment, the electrically conductive material of the core is dispersed in the dielectric matrix to make the heating element 520 electrically conductive. The heating element 520 may be configured to have low creep properties during thermal cycling. The working end 520A generates a sufficient amount of heat (e.g., it is heated until it glows) to initiate a catalytic reaction within the CPOx reactor 200 or the ATO 150 when a sufficient voltage, such as 20V to 30V, such as about 24V, is applied to the heating element 520.

The heating element 520 may extend through a central opening in the dielectric disk 530. The dielectric disk 530 is disposed adjacent to the first opening 512 in the first end 512E of the housing 510, such that the dielectric disk 530 supports and electrically insulates the terminal end 520B of the heating element 520. The dielectric disk 530 may be formed of a dielectric ceramic material, such as alumina or the like.

The heating element 520 (e.g., the heating core) may be electrically connected to the first terminal wire 522 and the second terminal wire 524, which are configured to provide voltage or current to the heating element. In particular, the first terminal wire 522 and the second terminal wire 524 may be brazed to the terminal end 520B of the heating element 520. The terminal wires 522, 524 may be formed of a metal having a high electrical conductivity and thermal stability, such as nickel. The dielectric disk 530 prevents or reduces hot gas from reaching the brazed joints connecting the terminal wires 522, 524 and the heating element 520. The dielectric disk 530 acts as an insulator for the brazed wire joints. Since brazed wire joints are close to the working end 520A of the heating element 520 which glows during operation, the dielectric disk 530 provides a sufficient dielectric gap to prevent short circuits.

In addition, the terminal wires 522, 524 may be at least partially surrounded by respective dielectric sheaths 526, 528, thereby preventing shorting between the two terminal wires 522, 524 and between the housing 510 and one or both of the terminal wires 522, 524. The sheaths 526, 528 may be formed of a dielectric ceramic material, such as alumina or the like.

The housing 510 may also be filled with a potting compound 518 configured to encapsulate the terminal wires 522, 524. In particular, the potting compound 518 and/or the sheaths 526, 528 may be configured to prevent electrical contact between the two terminal wires 522, 524 and between the housing 510 and one or more of the terminal wires 522, 524. For example, the potting compound 518 may be an electrically insulative resin, such as an epoxy resin or the like, or another electrically insulating material, such as an alumina or a zirconia potting compound, and may protect the terminal wires 522, 524 from shock and vibration, and may be configured to prevent fluids from entering the housing 510.

The terminal wires 522, 524 may extend through the brazed sealant assembly 540, which may be disposed in the second opening 514 and attached to the second end 514E of the housing 510. The brazed sealant assembly 540 may be welded to the housing 510. For example, the brazed sealant assembly 540 may be laser welded to the circular edge surface of the second end 514E of the housing 510.

FIG. 4A is a perspective view of the glow plug 500 with the brazed sealant assembly 540 removed. FIGS. 4B and 4C are perspective views of the brazed sealant assembly 540. FIG. 4D is an exploded view of the brazed sealant assembly 540, and FIG. 4E is a side cross-sectional view of the brazed sealant assembly 540.

Referring to FIGS. 4B-4E, the brazed sealant assembly 540 may include a cap 550, a first bushing 562, a second bushing 564, and a seal ring 570. The cap 550 may be formed of a dielectric ceramic material, such as alumina or the like. The cap 550 may include a recess 552 (i.e., a step in the outer diameter of the cap), a first through-hole 554, and a second through-hole 556. The recess 552 may extend around the perimeter of the cap 550 and may be configured to receive the seal ring 570, such that the seal ring 570 is mounted over the recess and brazed to two orthogonal (i.e., perpendicular) surfaces of the cap 550. The first through-hole 554 may include a relatively large diameter portion 554A which is larger than the outer diameter of the first bushing 562, and a relatively small diameter portion 554B for the terminal wire 522 feedthrough. The second through-hole 556 may include a relatively large diameter portion 556A which is larger than the outer diameter of the second bushing 564 and a relatively small diameter portion 556B for the terminal wire 524 feedthrough. The small diameter portions 554B, 556B are smaller than the respective large diameter portions 554A, 556A.

The large diameter portions 554A, 556A may be configured to receive the respective ends of the first and second bushings 562, 564. The first and second bushings 562, 564 are brazed to inner surfaces of the large diameter portions 554A, 556A of the respective first and second through-holes 554, 556. In one embodiment, first and second bushings 562, 564 do not extend into the small diameter portions 554B, 556B of the respective first and second through-holes 554, 556. The small diameter portions 554B, 556B may be configured to respectively receive the first and second terminal wires 522, 524. In some embodiments, the cap 550 may include a projection with a flat surface 558 in which the second through-hole 556 is formed. In particular, the cap 550 may have a stepped structure, such that the second through-hole 556 is longer than the first through-hole 554.

The first and second bushings 562, 564 may be hollow tubular structures configured to respectively receive the first and second terminal wires 522, 524. In some embodiments, the first and second bushings 562, 564 and the seal ring 570 may be formed of a nickel-cobalt ferrous alloy. For example, the first and second bushings 562, 564 and the seal ring 570 may be formed of a low coefficient of thermal expansion (CTE) alloy. In particular, the alloy may include, by weight, about 29% Ni, about 17% Co, less than about 0.01% C, about 0.2% Si, about 0.3% Mn, and a balance of Fe. However, the relative amounts of these components may be adjusted to achieve a desired coefficient of thermal expansion (CTE).

In various embodiments, the seal ring 570 and the bushings 562, 564 may be attached to the cap 550 using a braze material 580. In particular, the seal ring 570 may be brazed to the recess 552, while the bushings 562, 564 may be brazed to the through-holes 554, 556 of the cap 550, using an active metal brazing process, such as a high temperature vacuum brazing process. Active metal brazing allows metal to be joined to ceramic without metallization, using a braze material 580, such as an active braze alloy comprising silver, copper, and/or titanium. For example, suitable active braze alloys may include, by weight, about 72% Ag and about 28% Cu, or about 63.0% Ag, about 35.25% Cu, and about 1.75% Ti.

The recess 552 may increase the contact area between the cap 550 and the seal ring 570. In one embodiment shown in FIG. 4E, the seal ring 570 is brazed to both an axial surface 552A and the perpendicular radial surface 552R of the recess 552. Thus, the recess 552 may allow for a reduction in the thickness of the seal ring 570, without sacrificing bonding strength, which may beneficially minimize thermal expansion and/or contraction of the seal ring 570, such as during brazing and/or thermal cycling.

The projection 558 may be configured to reduce mixing of the braze material 580 used to attach the bushings 562, 564 to the cap 550. In particular, during brazing, the braze material 580 may overflow the through-holes 554, 556 onto the surface of the cap 550. The projection 558 may be configured to prevent contact between overflowed brazing material, thereby preventing the overflowed brazing material from electrically shorting the terminal wires 522, 524.

FIG. 5A is a perspective view of a glow plug 500 and first and second temperature sensors 209A, 209B being inserted into a CPOx reactor 200, and FIG. 5B is a side cross-sectional view of the CPOx reactor 200 containing the glow plug 500 and the temperature sensors 209A, 209B, according to various embodiments of the present disclosure. Referring to FIGS. 3A-5B, the CPOx reactor 200 may include a catalyst 204, a glow plug aperture 206, first and second sensor apertures 208A, 208B, a fuel inlet 212 and a fuel outlet 214. The catalyst 204 may be in the form of a porous catalyst bed or a porous substrate (e.g., a porous monolith) located in the reaction zone 201 in the interior of the CPOx reactor 200. Alternatively or in addition, the catalyst 204 may be coated on an internal sidewall of the CPOx reactor 200 in the reaction zone 201. The glow plug 500 may be inserted into the glow plug aperture 206, such that the working end 520A of the heating element 520 protrudes into the reaction zone 201 upstream of the catalyst 204 with respect to the fuel and air flow direction from the fuel inlet 212 to the fuel outlet 214. The fuel inlet 212 is fluidly connected to the fuel conduit 300A, and the fuel outlet 214 is fluidly connected to the fuel conduit 300B.

The first and second temperature sensors 209A, 209B may comprise any suitable temperature sensors, such as thermocouples. The first temperature sensor 209A may be inserted into the first sensor aperture 208A, such that a working end of the first temperature sensor 209A is located in the reaction zone 201 upstream of the catalyst 204. The second temperature sensor 209B may be inserted into the second sensor aperture 208B, such that a working end of the second temperature sensor 209B is located in the reaction zone 201 downstream of the catalyst 204.

The glow plug 500 and the temperature sensor(s) are located upstream and/or downstream of the catalyst 204 rather than being inserted into the catalyst 204. This placement of the glow plug and the temperature sensor(s) eliminates or reduces dead zones within the catalyst and reduces coking in the CPOx reactor 200.

During system 10 startup, power may be provided to the glow plug 500 to heat the working end 520A and thereby initiate a catalytic reaction of fuel and air flowing through the fuel inlet 212 into the catalyst 204 of the CPOx reactor 200 or the ATO 150. As such, during operation, the working end 520A of the heating element 520 may generate and/or be exposed to temperatures of 800° C. or higher during operation.

In one embodiment, the seal ring 570 and the bushings 562, 564 of the brazed sealant assembly 540 may have a maximum rated temperature of about 400° C., and the braze material 580 may have a maximum rated temperature of about 500° C., which are below the operating temperature of the working end 520A of the heating element 520. However, the housing 510 may separate the brazed sealant assembly 540 from the reaction zone 201 by a distance ranging from about 75 mm to about 150 mm, such as about 100 mm. As such, the brazed sealant assembly 540 may be exposed to temperatures of only about 300° C. or less, thereby protecting the brazed sealant assembly 540 from damage due to excessive temperatures.

In addition, the CTE of the cap 550, which may be formed of alumina, may be very close to the CTE of the seal ring 570 and the bushings 562, 564, which may be formed of a nickel-cobalt ferrous alloy. As a result, residual stress applied to the glow plug 500 during thermal cycling may be very low, which may protect the brazed joints of the brazed sealant assembly 540 from damage such as cracking during thermal cycling.

Fuel cell systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A glow plug, comprising:
a housing comprising a metal or metal alloy and having a first end having a first opening, and an opposing second end having a second opening;
a heating element extending through the first opening and having a working end that is exposed outside of the first end of the housing and an opposing terminal end that is located inside of the housing;
a brazed sealant assembly connected to the second end of the housing;
first and second terminal wires that extend through the brazed sealant assembly and are electrically connected to the terminal end of the heating element; and
a dielectric disk located inside of the housing and surrounding a portion of the terminal end of the heating element.

2. The glow plug of claim 1, wherein the brazed sealant assembly comprises:
a seal ring connected to the second end of the housing and comprising a metal or a metal alloy;
a cap connected to the seal ring and comprising a ceramic material; and
first and second bushings connected to the cap and comprising a ceramic material.

3. The glow plug of claim 2, wherein the seal ring is welded to the second end of the housing.

4. The glow plug of claim 2, wherein the cap is brazed to the seal ring.

5. The glow plug of claim 4, wherein:
the cap comprises a recess; and
the seal ring is mounted over the recess such that the seal ring is brazed to two surfaces of the cap.

6. The glow plug of claim 5, wherein the cap and the first and second bushings comprise alumina, and the seal ring comprises a nickel-cobalt ferrous alloy.

7. The glow plug of claim 4, wherein the first and second bushings are brazed to the cap.

8. The glow plug of claim 7, wherein the seal ring and the first and second bushings are brazed to the cap using an active braze alloy comprising:
silver and copper; or
silver, copper and titanium.

9. The glow plug of claim 7, wherein the cap comprises a first through-hole and a second through-hole.

10. The glow plug of claim 9, wherein:
the cap has a stepped structure, such that the second through-hole is longer than the first through-hole;
the stepped structure is configured to prevent electrical shorting of the first and second terminal wires by a braze material used to braze the first and second bushings to the cap;
the first and second through-holes each comprise a relatively large diameter portion and a relatively small diameter portion;
the first terminal wire extends through the first bushing and through the first through-hole to the terminal end of the heating element;
the second terminal wire extends through the second bushing and through the second through-hole to the terminal end of the heating element; and
the first and second bushings are brazed to inner surfaces of the large diameter portions of the first and second through-holes.

11. The glow plug of claim 1, further comprising first and second sheaths at least partially surrounding the first and second terminal wires, respectively, inside the housing,
wherein:
the housing comprises stainless steel; and
the dielectric disk and the first and second sheaths comprise a ceramic material.

12. The glow plug of claim 1, wherein the heating element comprises:
a core comprising molybdenum disilicide; and
a cladding or matrix that surrounds the core and comprises silicon nitride.

13. The glow plug of claim 1, further comprising a potting material located inside the housing.

14. A fuel cell system, comprising:
the glow plug of claim 1; and
fuel cell stacks located in a hot box.

15. The fuel cell system of claim 14, further comprising a catalytic partial oxidation (CPOx) reactor comprising a CPOx housing surrounding a reaction zone and a catalyst located in the reaction zone, wherein the glow plug extends through the CPOx housing into the reaction zone and is located upstream of the catalyst, with respect to a fuel flow direction through the CPOx reactor.

16. The fuel cell system of claim 15, further comprising:
a first temperature sensor inserted into the CPOx reactor upstream of the catalyst; and
a second temperature sensor inserted into the CPOx reactor downstream of the catalyst.

17. The fuel cell system of claim 14, further comprising an anode tail gas oxidizer (ATO) located in the hotbox, wherein the working end of the glow plug is configured to heat a fuel exhaust and air mixture provided into the ATO.

18. A catalytic partial oxidation (CPOx) reactor, comprising:
a CPOx housing surrounding a reaction zone;
a catalyst located in the reaction zone; and
a glow plug that extends through the CPOx housing into the reaction zone and that is located upstream of the catalyst with respect to a fuel flow direction through the CPOx reactor.

19. The CPOx reactor of claim 18, further comprising:
a first temperature sensor inserted into the reaction zone upstream of the catalyst; and
a second temperature sensor inserted into the reaction zone downstream of the catalyst.

20. A fuel cell system, comprising:
the CPOx reactor of claim 18; and
fuel cell stacks located in a hot box.
